(19) United States
(12) Patent Application Publication
(10) Pub. No.: US 2017/0220623 A1
(43) Pub. Date: Aug. 3, 2017

(54) Hot-Spot Adaptive Garbage Collection

(71) Applicant: NetApp, Inc., Sunnyvale, CA (US)

(72) Inventors: Joseph Blount, Wichita, KS (US); Joseph Moore, Wichita, KS (US); William P. Delaney, Wichita, KS (US); Randolph Sterns, Boulder, CO (US)

(21) Appl. No.: 15/010,624

(22) Filed: Jan. 29, 2016

(51) Int. Cl. G06F 17/30; G06F 12/02

(52) U.S. Cl. CPC G06F 17/30371; G06F 12/0269; G06F 17/3053

(57) ABSTRACT

A method, a computing device, and a non-transitory machine-readable medium for assessing data segments for garbage collection is provided. In some embodiments, the method includes identifying a plurality of data segments. A first rate at which data within each of the plurality of data segments has been invalidated since a first point in time is determined, and a second rate at which data within each of the plurality of data segments has been invalidated since a second point in time subsequent to the first point in time is determined. The second rate is compared to the first rate for each of the plurality of data segments, and a garbage collection score is assigned to the respective data segment based on the comparison. The garbage collection score may be further based on a utilization of the respective data segment and/or an age of the respective data segment.

### TECHNICAL FIELD

The present description relates to data storage, and more specifically, to a technique for determining which segments of an address space to perform garbage collection on based on the amount of valid data, segment age, data invalidation trends and/or other factors.

### BACKGROUND

The trend of modern applications to demand ever-increasing amounts of data and to demand better performance has spurred rapid developments in both storage systems and storage technologies. To support these applications, storage architectures incorporate Network Attached Storage (NAS) devices. Storage Area Network (SAN) devices, and other configurations of storage systems, storage devices, and controllers. Despite the proliferation of Solid State Devices (SSD), battery-backed RAM disks, and other technologies, magnetic hard disk drives (HDD) remain the backbone of many of these storage architectures. Because of their high capacities and attractive cost-per-byte, HDDs store the bulk of the data even though they often have latencies that are an order of magnitude greater than the next fastest technology. The nature of rotating platters and seeking heads means that random read/write performance is particularly slow.

In order to address some of these performance concerns and to increase bit density, HDDs have evolved considerably. For example, some HDDs utilize overlapping data tracks where each track is actually smaller than the minimum writable area. This may prevent write-in-place operations but this can be rectified by utilizing data indirection where new data is written to a fresh location and the old data is merely invalidated. This has a side benefit of replacing random writes with sequential writes, which may further improve performance. Data indirection is also used in other data storage technologies, such as SSDs, where it is used for wear leveling, parallelization, and other purposes.

As a consequence of data indirection, garbage collection has become increasingly relevant to storage performance. Garbage collection is a process of identifying, valid data amidst those portions of a data set that are invalid. During garbage collection, invalid data may be removed and valid data may be compacted by copying the valid data out to a new location.

However, garbage collection can be burdensome, and in a typical example, garbage collection on a 1 GB data set may involve transferring between 4-6 GB or more of data. Accordingly, while conventional garbage collection techniques have been generally adequate, an improved system and method for identifying data segments to garbage collect has the potential to dramatically reduce the impact of garbage collection while providing better device performance.

### BRIEF DESCRIPTION OF THE DRAWINGS

The present disclosure is best understood from the following detailed description when read with the accompanying figures.

FIG. 1 is a schematic diagram of a data storage architecture according to aspects of the present disclosure.

FIG. 2 is a diagram of a data region of a storage device according to aspects of the present disclosure.

FIG. 3 is a flow diagram of a method of garbage collection according to aspects of the present disclosure.

FIG. 4 is a schematic diagram of a data storage architecture for performing the method of garbage collection according to aspects of the present disclosure.

FIG. 5 is a memory diagram of garbage collection metadata according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments unless otherwise noted. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for improved garbage collection that determine which segments to perform garbage collection on based on each segment's utilization, age, recent invalidation trends, and/or other factors. In an exemplary embodiment, a storage system divides an address space into a set of segments. The storage system records metadata for each segment as subsequent writes invalidate data within the segment. When garbage collection is initiated, the storage system considers aspects of each segment such as the amount of valid data and the segment's age to determine which segments to garbage collect, if any. The storage system may also consider whether a segment has seen an unusually large amount of data invalidated recently. If so, it may indicate that the segment contains a data hot spot. Garbage collection for segments with hot spots may be delayed because the valid data is likely to be invalidated again shortly thereafter. Once one or more segments have been selected for garbage collection, the storage system copies the valid data from the selected segment(s) to a new segment and marks the entire segment(s) from which the data was copied as invalid.

The present garbage collection technique may react to changes in a workload to determine those segments that free up the most space while deprioritizing data that is likely to be invalidated soon. Accordingly, the present technique better discerns those segments which provide the greatest garbage collection benefit in view of data age, utilization, and workload. This can provide significant benefits. Garbage collection is often burdensome and frequently has a write-multiplying effect. Reducing the number of segments being garbage collected or at least focusing garbage collection on those segments that provide the greatest benefit may alleviate some of this burden.

Garbage collection is growing in importance for several reasons. One is that magnetic Hard Disk Drives (HDDs) have much better sequential read and write performance than random performance. In order to replace random I/O's with sequential I/O's, some storage environments use data indirection when storing to an HDD. In such examples, data is written sequentially regardless of where the data fits into the address space. If new data replaces old, the old data is invalidated instead of being overwritten. Because such techniques may leave valid data interspersed with invalid data, garbage collection is performed to extract the valid data and free additional space for writing. Thus, the importance of efficiency may grow as HDDs move to away from random writes. These advantages and examples are not limited to HDDs as garbage collection is used with SSDs and other storage technologies as well. In this way, the techniques of the present disclosure provide significant, meaningful, real-world improvements to conventional garbage collection techniques. Of course, these advantages of the present technique are merely exemplary, and no particular advantage is required for any particular embodiment.

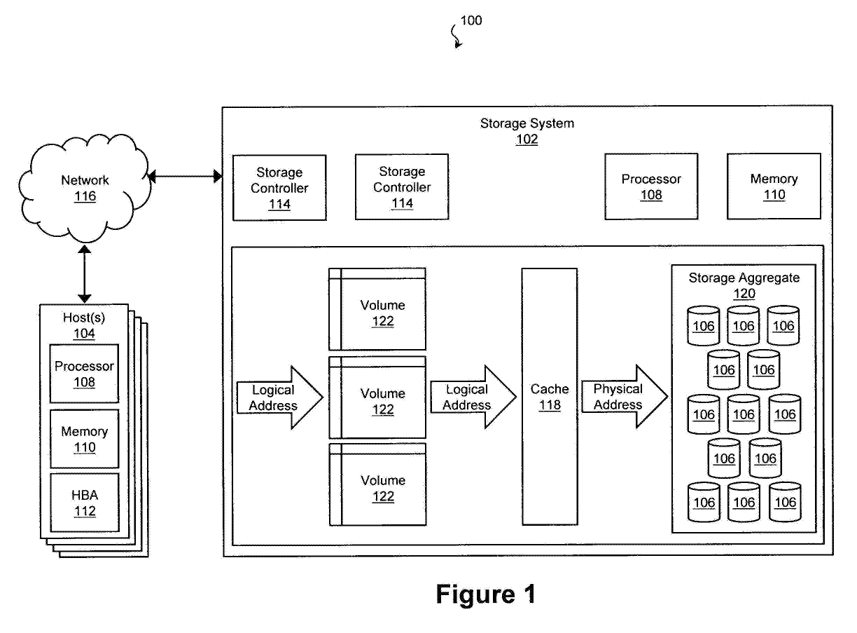

FIG. 1 is a schematic diagram of a data storage architecture 100 according to aspects of the present disclosure. The data storage architecture 100 includes a storage system 102 that processes data transactions on behalf of other computing systems including one or more hosts 104. The storage system 102 is only one example of a computing system that may perform data storage and garbage collection. It is understood that present technique may be performed by any computing system (e.g., a host 104 or third-party system) operable to read and/or write data from any suitable storage device 106. As some storage devices 106 perform aspects of data indirection and garbage collection, the present technique may be performed by the storage devices 106 in conjunction with the computing system or by the storage devices 106 alone.

The exemplary storage system 102 receives data transactions (e.g., requests to read and/or write data) from the hosts 104 and takes an action such as reading, writing, or otherwise accessing the requested data so that the storage devices 106 of the storage system 102 appear to be directly connected (local) to the hosts 104. This allows an application running on a host 104 to issue transactions directed to the storage devices 106 of the storage system 102 and thereby access data on the storage system 102 as easily as it can access data on the storage devices 106 of the host 104. It is understood that for clarity and ease of explanation, only a single storage system 102 and a single host 104 are illustrated, although the data storage architecture 100 may include any number of hosts 104 in communication with any number of storage systems 102.

Furthermore, while the storage system 102 and the hosts 104 are referred to as singular entities, a storage system 102 or host 104 may include any number of computing devices and may range from a single computing system to a system cluster of any size. Accordingly, each storage system 102 and host 104 includes at least one computing system, which in turn may include a processor 108 operable to perform various computing instructions, such as a microcontroller, a central processing unit (CPU), or any other computer processing device. The computing system may also include a memory device 110 such as random access memory (RAM); a non-transitory machine-readable storage medium such as a magnetic hard disk drive (HDD), a solid-state drive (SSD), or an optical memory (e.g., CD-ROM, DVD, BD); a video controller such as a graphics processing unit (GPU); a communication interface such as an Ethernet interface, a Wi-Fi (IEEE 802.11 or other suitable standard) interface, or any other suitable wired or wireless communication interface; and/or a user I/O interface coupled to one or more user I/O devices such as a keyboard, mouse, pointing device, or touchscreen.

With respect to the hosts 104, a host 104 includes any computing resource that is operable to exchange data with a storage system 102 by providing (initiating) data transactions to the storage system 102. In an exemplary embodiment, a host 104 includes a host bus adapter (HBA) 112 in communication with a storage controller 114 of the storage system 102. The HBA 112 provides an interface for communicating with the storage controller 114, and in that regard, may conform to any suitable hardware and/or software protocol. In various embodiments, the HBAs 112 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire. In many embodiments, the host HBAs 112 are coupled to the storage system 102 via a network 116, which may include any number of wired and/or wireless networks such as a Local Area Network (LAN), an Ethernet subnet, a PCI or PCIe subnet, a switched PCIe subnet, a Wide Area Network (WAN), a Metropolitan Area Network (MAN), the Internet, or the like. To interact with (e.g., read, write, modify, etc.) remote data, the HBA 112 of a host 104 sends one or more data transactions to the storage system 102 via the network 116. Data transactions may contain fields that encode a command, data (i.e., information read or written by an application), metadata (i.e., information used by a storage system to store, retrieve, or otherwise manipulate the data such as a physical address, a logical address, a current location, data attributes, etc.), and/or any other relevant information.

With respect to the storage system 102, the exemplary storage system 102 contains one or more storage controllers 114 that receive the transactions from the host(s) 104 and that perform the data transaction using a hierarchical memory structure. The memory structure may include a cache 118 with any number of cache levels and a storage aggregate 120. The storage aggregate 120 and the cache 118 are made up of any suitable storage devices using any suitable storage media including electromagnetic hard disk drives (HDDs), solid-state drives (SSDs), flash memory, RAM, optical media, and/or other suitable storage media. In an exemplary embodiment, the cache 118 includes battery-backed RAM and/or SSDs, while the storage aggregate 120 include HDDs. Of course, these configurations are merely exemplary, and the storage aggregate 120 and the cache 118 may each include any suitable storage device or devices in keeping with the scope and spirit of the present disclosure.

The storage controllers 114 may group the storage devices 106 of the storage aggregate 120 for speed and/or redundancy using a virtualization technique such as RAID (Redundant Array of Independent/Inexpensive Disks). At a high level, virtualization includes mapping physical addresses of the storage devices into logical block addresses (LBAs) in a virtual address space and presenting the virtual address space to the hosts 104. In this way, the storage system 102 represents the portions of the address space as single devices, often referred to as volumes 122, regardless of how they are actually distributed on the underlying storage devices 106.

The storage controllers' conversion of the data transactions from volume-based LBAs to physical block addresses of the storage devices 106 provides a mechanism to convert random data writes into sequential writes because sequential writes are often faster and have other benefits described in more detail below. In an example of a sequential write sequence, each write in the sequence is directed to the next physical address in a monotonically increasing order. By manipulating an LBA to physical address mapping, writes can be made sequential even when the LBAs are not. In other words, a storage controller can map each subsequent write transaction to the next available physical address regardless of the associated LBA. If the write transaction replaces a previous value at the same LBA, the previous value may be invalidated and left on the disk rather than overwritten. As a consequence, invalid data may begin to permeate the valid data. Sequential writes are most effective when large block ranges of a storage device 106 are available for writing, and so garbage collection may be performed to copy the valid data out to create large contiguous block ranges for subsequent writing. It should be noted that sequential writing does not require that all the data be written at once without interruption.

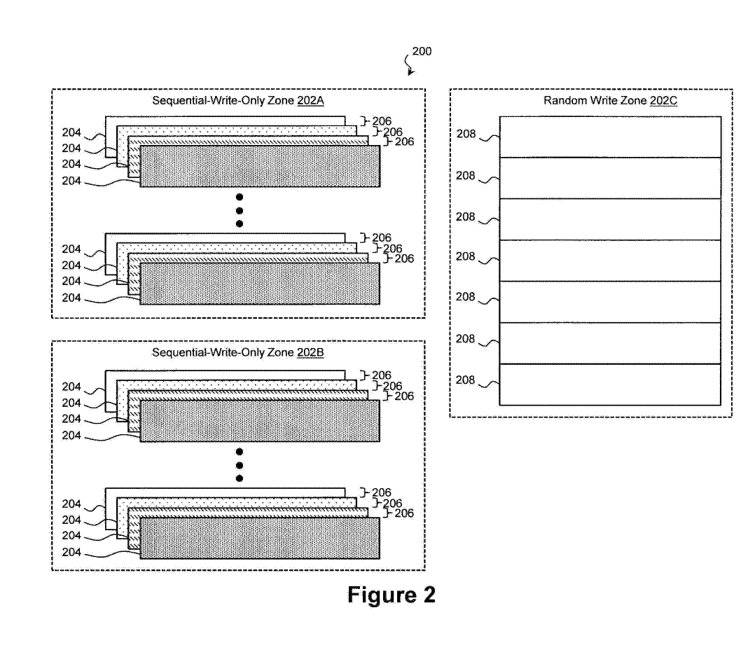

An example of a storage device 106 that relies on sequential writing to improve data density and perfoiinance is illustrated in FIG. 2. In that regard, FIG. 2 is a diagram of a data region 200 of a storage device 106 according to aspects of the present disclosure. The illustrated storage device 106 is exemplary of a magnetic HDD, but it is representative of any suitable storage technology.

The data region of the storage device 106 may be divided into one or more zones. In the illustrated example, zones 202A and 202B are designated as sequential-write-only zones, while zone 202C allows random writes. By designating zones 202A and 202B as sequential-write-only, the tracks may be overlapped to increase storage density. Specifically, the mechanics of writing to the storage device 106 may be such that the minimum writable area may be larger than the minimum readable area. Thus, a pass of a write head may modify a write track 204 of a particular width as shown. The next write to the next write track 204 may overlap and overwrite part of the first track while leaving a portion intact to serve as a read track 206. In this way, the overlapping or “shingled” write tracks 204 create a layered structure. This may allow the storage device to store data in read tracks 206 smaller than a write track 204 and may increase the data density. However, as a consequence, a write in, the middle of a sequential-write-only zone risks overwriting several adjacent read tracks 206. To avoid this, the storage controller 114 and the storage device 106 may collaborate to ensure that each write to the sequential-write-only zones is sequential regardless of the LBA written to by the application.

In contrast, some portions of the data region 200 may be designated for random writes, such as zone 2020. Zone 202C may lack overlapping tracks so that writing to a particular track (e.g., read/write track 208) does not disturb adjacent tracks 208. In many examples, the read/write tracks 208 in the random write zones 202C are larger than those of the sequential-write-only zones 202A and 202B, and accordingly, different read and write heads may be used in the random-write zones 202C. This trades data density for random write ability. The storage controller 114 may allocate data between the sequential-write-only zones 202A and 202B and the random-write zone 202C based on the frequency with which it is overwritten and other suitable factors.

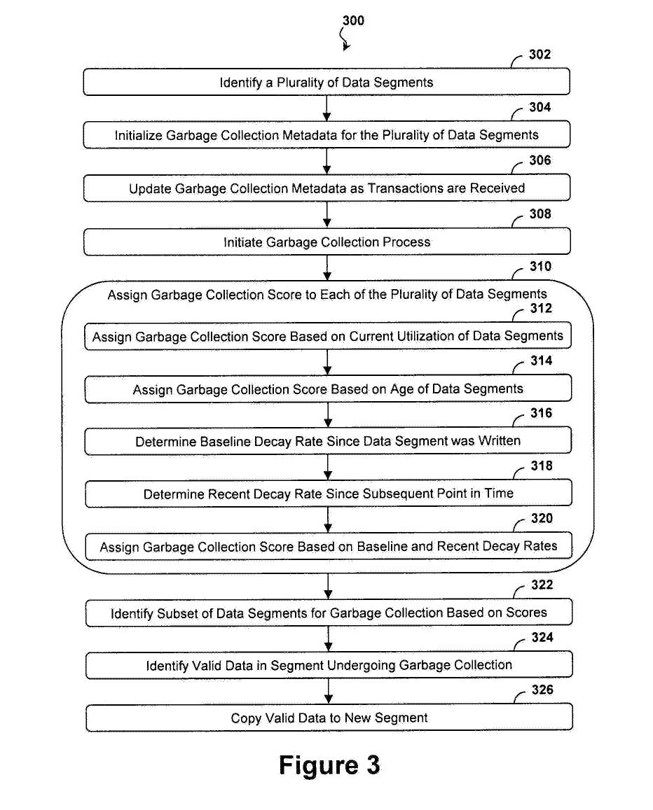

Because of the sequential-write nature of zones 202A and 202B, garbage collection may be performed on these zones to copy valid data out to the zone currently being written and to mark the entire zone available for the next write process. A method of garbage collection suitable for use with such a storage device 106 is disclosed with reference to FIGS. 3-5. Of course, the storage device 106 of FIG. 2 is only one possible storage device 106 that may be used in conjunction with the system and method of the present disclosure, and the principles disclosed herein apply equally to any suitable storage device 106. For example, the method is also suitable for use with storage devices 106 that do not use shingled or overlapping tracks, such as SSDs.

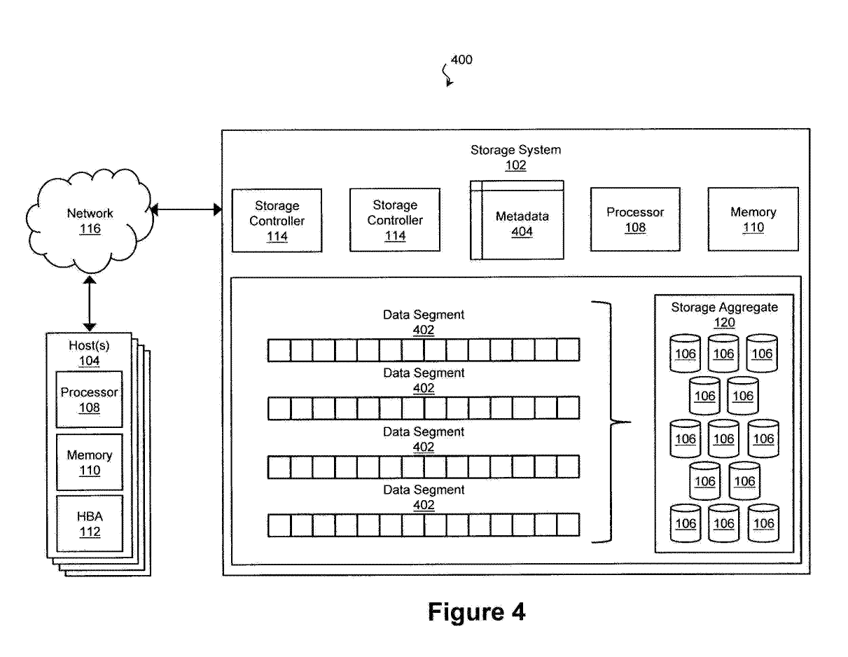

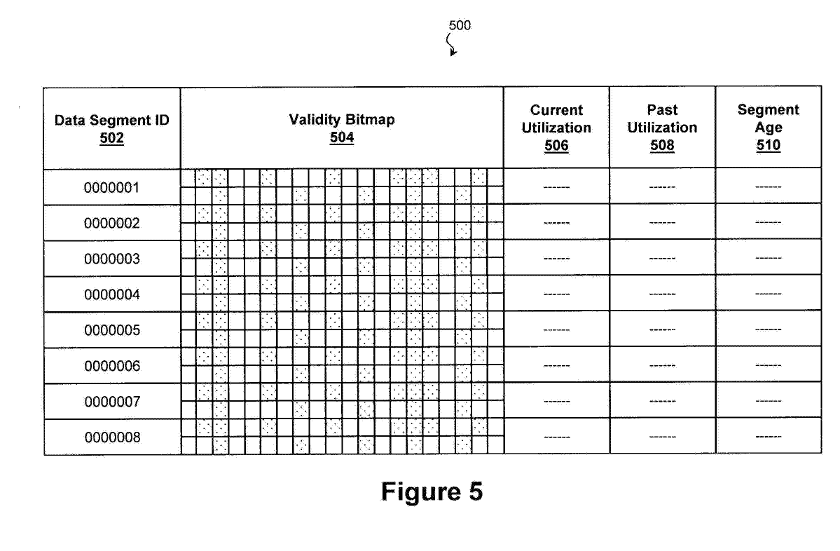

FIG. 3 is a flow diagram of a method 300 of garbage collection according to aspects of the present disclosure. It is understood that additional steps can be provided before, during, and after the steps of method 300, and that some of the steps described can be replaced or eliminated for other embodiments of the method. FIG. 4 is a schematic diagram of a data storage architecture 400 for performing the method 300 that is substantially similar to that of FIG. 1 in many respects. The method may be performed by the storage system 102 of FIG. 4 or any other suitable computing system, and while many processes are disclosed as being performed by a storage controller 114 of the storage system 102, these same processes may be performed by any suitable computing element such as the processor 108 of the storage system 102. FIG. 5 is a memory diagram of garbage collection metadata according to aspects of the present disclosure.

Referring to block 304 of FIG. 3 and to FIG. 4, the storage controller 114 or other suitable element of the storage system 102 identifies a plurality of data segments 402 within the address space of the storage devices 106. Each data segment 402 represents a monolithic block of data addresses that contains some combination of valid data, invalid data, and, if it has not been filled, unallocated space. If selected for garbage collection, a data segment 402 will be analyzed, valid data will be copied out to a different data segment 402, and the entire data segment 402 being garbage collected will be invalidated. The invalid data segment 402 is then available for writing anew.

The data segments 402 may have any suitable size based on any suitable attributes of the storage devices 106, the storage system 102, a file system, and/or any other element of the storage architecture 100. In some examples, the data segment size is selected based on the zone size of the sequential-write-only zones (e.g., zones 202A and 202B) of the storage devices 106. When the storage devices are arranged as a RAID array or other grouping, the data segment size may also be based on the grouping. For example, the data segment size may be selected to be a multiple of the storage device zone size multiplied by the number of non-parity storage devices 106 in a RAID array. The benefit of this size is that it does not divide any sequential-write-only zones (e.g., zones 202A and/or 202B) within the RAID stripe into more than one data segment 402. Similarly, SSD storage devices 106 may have a minimum readable/writable unit called a page and a separate minimum erasable unit called an erase page or a block, In embodiments utilizing an SSD, the data segment size may be selected to be a multiple of the erase page size multiplied by the number of non-parity storage devices 106 in the RAID array. It is further noted that data segments 402 do not need to be uniform in size, and a storage controller 114 may maintain data segments 402 of different sizes on a single set of storage devices 106.

Referring to block 302 of FIG. 3 and to FIG. 4, the storage controller 114 or other element of the storage system 102 initializes a set of garbage collection metadata 404 for the address space. The garbage collection metadata 404 may be used to assign a score to each data segment 402 that determines whether garbage collection is performed on the data segment 402 and accordingly, the garbage collection metadata 404 may record any suitable attribute associated with a data segment 402 that affects the respective garbage collection score. The metadata 404 may be maintained in any suitable representation including a linked list, a tree, a table such as a hash table, an associative array, a state table, a flat file, a relational database, and/or other memory structure.

In an example of garbage collection metadata 404 illustrated in FIG. 5, the metadata 404 is arranged by data segment 402, and each segment has a corresponding entry. An exemplary entry for a data segment may include a corresponding segment ID 502, a validity bitmap 504 or other structure recording which data extents within the segment are valid, a current utilization entry 506 representing a total of valid data within the data segment 402, one or more past utilization entries 508 representing total valid data at various points in time, and/or an age entry 510. Age may be measure from the first write to the data segment 402, from the time the segment 402 was filled and closed to further writes, or any point therebetween. However, because representing segment age as a factor of time may not properly account for periods of system inactivity, in some embodiments, age is better represented in terms of disk activity. In one such example, the garbage collection metadata 404 records age 510 in terms of the number of other segments that were closed to further writes after the respective data segment was written (first written, closed, or in between). Other suitable measurements of disk activity include a count of other segments being erased and opened to further writes, a count of host writes, a counts of host I/Os, and/or other activity metrics. The garbage collection metadata 404 records age 510 in terms of the selected metric(s). Referring to block 306 of FIG. 3, the storage controller 114 or other element of the storage system 102 updates the garbage collection metadata 404 as transactions are received and data is written to the storage devices 106. However, it is not necessary to update all entries of the metadata 404 each time data is written, and some entries of the garbage collection metadata 404 may be updated when garbage collection begins instead.

Referring to block 308 of FIG. 3, the storage controller 114 or other element of the storage system 102 initiates a garbage collection process upon detecting a trigger. The garbage collection may be initiated in response to any suitable trigger, such as a certain interval of time, a certain number of writes or segment closures, invalid data exceeding a threshold, system activity falling below a threshold, a system maintenance task, a user command, and/or any other suitable trigger.

Referring to block 310 of FIG. 3, as part of the garbage collection process, the storage controller 114 or other element of the storage system 102 may assign a garbage collection score to each of the data segments 402 based on the attributes recorded in the garbage collection metadata 404 as well as other segment attributes. The garbage collection score may weigh the burden of copying the valid data against benefits such as the amount of space that will be freed by garbage collecting the respective segment, the longevity of the valid data being copied out from the segment, any performance increase expected from garbage collecting the segment, and/or any other suitable factors. Various examples are explained below.

In some embodiments, the storage controller 114 or other element of the storage system 102 considers the utilization or the ratio of valid to invalid data in the data segment in determining the segment's garbage collection score as shown in block 312. Utilization may be positively correlated with the desirability of performing garbage collection for a number of reasons, each of which may be accounted for in determining the score. For example, performing garbage collection on a segment with more invalid data may be beneficial because more space on the storage devices 106 is freed by garbage collection. Another benefit of low utilization is that less valid data is copied out during garbage collection. Utilization may be determined from the current utilization entry 506 in the garbage collection metadata 404 and/or any other suitable metadata.

Referring to block 314, in some embodiments, the storage controller 114 or other element of the storage system 102 accounts for the age of the data segment when assigning a garbage collection score. Age may be measured from the first write to the data segment 402, from the time the segment 402 was filled and closed, or any point therebetween and may be determined from the age entry 510 in the garbage collection metadata 404. Segment age may be positively correlated with the desirability of performing garbage collection because the valid data in older segments is generally more stable and less likely to be invalidated. Accordingly, any reclaimed space may last longer.

In an example, the storage system 102 assigns a score based on utilization determined in block 312 and age determined in block 314 utilizing an equation of the form:

$$Score = \frac{( 1 - U ) * Age}{1 + U}$$

The variable Score represents the garbage collection desirability of the data segment 402 with a greater score being more desirable. Thus, a higher Score increases the likelihood that the segment 402 is selected for garbage collection. U represents the current utilization of the data segment 402 and may be expressed as a ratio of valid to invalid data, a percentage of valid data, or other suitable expression. Age represents the age of the data segment. As disclosed above, representing Age as a measure of time may not properly account for idle periods. Therefore, Age in the above equation may be represented by a unit of disk activity (such as segment closures) occurring since the data segment was written (first written, last written, closed, etc.).

It has further been determined that for some workloads, this type of equation either over-emphasizes or under-emphasizes the effect of data segment age. Accordingly, in some embodiments, the storage controller 114 applies an equation of the form:

$$Score = \frac{( 1 - U ) * {Age}^{X}}{1 + U}$$

where Score, U, and Age are substantially as described above and X is an age scaling factor. The age-scaling factor may be determined by observing the pattern of data accesses and invalidation associated with a given workload and determining the relative stability of the dataset. For workloads where older data tends to be more stable, the contribution of data age may be increased by increasing X. Conversely, for workloads with more random data access patterns, the contribution of data age may be decreased by decreasing X.

Workload may be accounted for in other manners as well. For example, the storage controller 114 or other element of the storage system 102 may observe the pattern of invalidations in order to infer hot spots in the dataset where invalidations are frequent. Data segments 402 that contain hot spots may be deprioritized because the increased number of writes suggests that any gains in space created by garbage collection are more likely to be lost when the valid data is subsequently invalidated. In other words, the storage system 102 may use the score to delay garbage collection for segments 402 experiencing a large number of write invalidations. Because the hot spots may not be stable over time, in some embodiments, the storage controller 114 reassesses the hot spots each time scoring is performed.

In some such embodiments, the storage controller 114 infers hot spots by comparing recent activity in the data segment 402 with historical activity. Referring to block 316, the storage controller 114 first determines a baseline decay rate for each data segment 402 since it was written based on the total amount of data that is currently invalid in the respective data segment 402 divided by the age of the data segment 402 expressed in a unit of disk activity (e.g., segment closures) or time. The amount of invalid data may be determined from the current utilization entry 506 in the garbage collection metadata 404. Referring to block 318, the storage controller 114 then determines a recent decay rate based on the amount of data invalidated since a subsequent (more recent) point in time (based on the past utilization entries 508), such as the last time garbage collection was run. In such an example, the storage controller 114 determines the recent decay rate based on the amount of data invalidated since the last garbage collection divided by the amount of time since garbage collection was run expressed as a unit of disk activity (e.g., segment closures) or time.

It has been determined that the larger the recent decay rate is relative to the baseline decay rate, the more likely the data segment 402 is to be home to a current hot spot. In terms of garbage collection, it may be beneficial to delay performing garbage collection until the recent decay rate falls closer to the baseline decay rate because while the hot spot is occurring, the valid data copied out is likely to be invalidated thus negating the benefit of garbage collection.

Referring to block 320, the storage controller 114 determines a garbage collection score for a data segment that accounts for the hot spots by applying an equation of the form:

$$Score = \frac{( 1 - U ) * {Age}^{X}}{( 1 + U ) * ( 1 + Excess Recent Decay )}$$

where Score, U, Age, and X are substainally as described above and Excess Recent Decay is a measure of a recent decay rate since the last garbage collection or other point in time compared to a baseline decay rate since the data segment was written. In some such embodiments, Excess Recent Decay is the ratio of the recent decay rate to the baseline decay rate. A constant (e.g., “1”) may be added to the Excess Recent Decay to avoid a divide by zero error and other distortions should the value approach 0. As will be recognized, as the ratio of the recent decay rate to the baseline decay rate increase, Score decreases, which reduces the likelihood that garbage collection will be performed on the respective data segment 402.

As with the Age factor, this type of equation may over-emphasize or under-emphasize the effect of the Excess Recent Decay. Accordingly, in some embodiments, the storage controller 114 applies an equation of the form:

$$Score = \frac{( 1 - U ) * {Age}^{X}}{( 1 + U ) * ( 1 + Excess Recent {Decay}^{Y} )}$$

where Score, U, Age, X, and Excess Recent Decay are substantially as described above and where Y is a decay scaling factor. The decay scaling factor may be determined by observing the pattern of data accesses and invalidation associated with a given workload and determining the relative stability of the dataset. For workloads where the hot spot does not persist as long or where the hot spot moves frequently, the contribution of Excess Recent Decay may be decreased by decreasing Y. Conversely, for workloads with more stable hot spot behavior, the contribution may be increased by increasing Y.

By these techniques and others, the storage controller 114 or other element of the storage system 102 determines a garbage collection score for each data segment 402 representing the desirability of garbage collecting the segment 402. Referring to block 322 of FIG. 3, the storage controller 114 or other element of the storage system 102 identifies a subset of the data segments 402 for garbage collection based on the respective scores assigned in blocks 310-320. To do so, the storage controller 114 may compare the scores to various thresholds. Additionally or in the alternative, the storage controller 114 may elect to perform garbage collection on a certain percentage of the total number of data segments 402 and/or on those segments meeting any other consideration. In some embodiments, the number of data segments 402 selected depend on external factors such as system load, and in one such example, the storage controller 114 selects fewer data segments 402 for garbage collection when the storage system 102 is heavily loaded.

Referring to block 324 of FIG. 3, for each data segment 402 selected for garbage collection, the storage controller 114 identifies the valid data within the segment, and referring to block 326 of FIG. 3, the storage controller 114 copies the valid data to a new data segment 402. Because only the valid portion of the data is copied from the data segment 402, data from multiple segments being garbage collected may be copied into the same destination data segment 402. After the valid data is complete, the entire data segment 402 from which the data was copied is marked as invalid and the data segment 402 is opened for writing again.

As will be recognized, the method 300 provides an improved technique for scoring data segments for garbage collection that accounts for trends in current disk activity. The present garbage collection technique may identify those segments that free up the most space while deprioritizing data that is likely to be invalidated because of a hot spot. In this way and others, the present technique specifically addresses the technical challenge of discerning those segments which provide the greatest garbage collection benefit and provides a significant and substantial improvement over conventional garbage collection techniques.

In various embodiments, the technique is performed by using various combinations of dedicated, fixed-function computing elements and programmable computing elements executing software instructions. Accordingly, it is understood that any of the steps of method 300 may be implemented by a computing system using corresponding instructions stored on or in a non-transitory machine-readable medium accessible by the processing system. For the purposes of this description, a tangible machine-usable or machine-readable medium can be any apparatus that can store the program for use by or in connection with the instruction execution system, apparatus, or device. The medium may include non-volatile memory including magnetic storage, solid-state storage, optical storage, cache memory, and/or Random Access Memory (RAM).

Thus, the present disclosure provides a method, a computing device, and a non-transitory machine-readable medium for scoring data segments for garbage collection that reacts to a changing workload and identifies those data segments where garbage collection provides the greatest benefit.

In some embodiments, the method includes identifying, by a computing system, a plurality of data segments. The computing system determines a first rate at which data within each of the plurality of data segments has been invalidated since a first point in time and a second rate at which data within each of the plurality of data segments has been invalidated since a second point in time subsequent to the first point in time. The computing system compares the second rate to the first rate for each of the plurality of data segments, and assigns a garbage collection score to each of the plurality of data segments based on the comparison of the second rate to the first rate of the respective data segment. In some such embodiments, the second point in time corresponds to a previous garbage collection process. In some such embodiments, the computing system assigns the garbage collection score to each of the plurality of data segments further based on at least one attribute selected from the group consisting of: a utilization of the respective data segment and an age of the respective data segment.

In further embodiments, the non-transitory machine readable medium has stored thereon instructions for performing a method comprising machine executable code which when executed by at least one machine, causes the machine to: identify a plurality of data segments; determine an amount of valid data in each of the plurality of data segments; determine an age of each of the plurality of data segments; and assign a garbage collection score to each of the plurality of data segments based on the amount of valid data in the respective data segment and based on the age of the respective data segment scaled by a workload-based scaling factor. In some such embodiments, the age of each of the plurality of data segments is represented in a disk access metric and the disk access metric includes a count of data segment being closed to further writes.

In yet further embodiments, the computing device includes a memory containing machine readable medium comprising machine executable code having stored thereon instructions for performing a method of garbage collection assessment; and a processor coupled to the memory. The processor is configured to execute the machine executable code to cause the processor to: identify a plurality of data segments; and for each of the plurality of data segments: determine a first rate at which data within the respective data segment has been invalidated since a first point in time; determine a second rate at which data within the respective data segment has been invalidated since a second point in time subsequent to the first point in time; compare the second rate to the first rate; and assign a garbage collection score to the respective data segment based on the comparison of the second rate to the first rate of the respective data segment. In some such embodiments, the garbage collection score is selected such that a likelihood that garbage collection is performed on a data segment of the plurality of data segments is inversely proportional to a ratio of the second rate to the first rate.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
identifying, by a computing system, a plurality of data segments;
determining a first rate at which data within each of the plurality of data segments has been invalidated since a first point in time;
determining a second rate at which, data within each of the plurality of data segments has been invalidated since a second point in time subsequent to the first point in time;
comparing the second rate to the first rate for each of the plurality of data segments; and
assigning a garbage collection score to each of the plurality of data segments based on the comparison of the second rate to the first rate of the respective data segment.

2. The method of claim 1, wherein the second point in time corresponds to a previous garbage collection process.

3. The method of claim 1, wherein the garbage collection score is selected to reduce a likelihood that garbage collection is performed on a data segment of the plurality of data segments as a ratio of the second rate to the first rate increases.

4. The method of claim 1 further comprising assigning the garbage collection score to each of the plurality of data segments further based on at least one attribute selected from the group consisting of: a utilization of the respective data segment and an age of the respective data segment.

5. The method of claim 4, wherein the at least one attribute is selected to include the age of the respective data segment, and wherein the age of the respective data segment is represented in a disk access metric.

6. The method of claim 5, wherein the disk access metric includes at least one metric selected from the group consisting of: a count of data segments being closed to further writes; a count of data segments being opened to further writes; a count of host I/Os; and a count of host writes.

7. The method of claim 1 further comprising performing a garbage collection process on a subset of the plurality of data segments based on the assigned garbage collection score.

8. The method of claim 1, wherein the assigning, of the garbage collection score is in accordance with an equation of the form:
$$Score = \frac{( 1 - U ) * {Age}^{X}}{( 1 + U )}$$
where Score represents the garbage collection score, U represents a segment utilization metric, Age represents a segment age, and X represents an age scaling factor.

9. The method of claim 1, wherein the assigning of the garbage collection score is in accordance with an equation of the form:
$$Score = \frac{( 1 - U ) * {Age}^{X}}{( 1 + U ) * ( 1 + Excess Recent {Decay}^{Y} )}$$
where Score represents the garbage collection score, U represents a segment utilization metric, Age represents a segment age, X represents an age scaling factor, Excess Recent Decay represents a ratio of the second rate to the first rate, and Y represents a decay scaling factor.

10. A non-transitory machine readable medium having stored thereon instructions for performing a method comprising machine executable code, which when executed by at least one machine, causes the machine to:
identify a plurality of data segments;
determine an amount of valid data in each of the plurality of data segments;
determine an age of each of the plurality of data segments; and
assign a garbage collection, score to each of the plurality of data segments based on the amount of valid data in the respective data segment and based on the age of the respective data segment scaled by a workload-based scaling factor.

11. The non-transitory machine readable medium of claim 10, wherein the age of each of the plurality of data segments is represented in a disk access metric.

12. The non-transitory machine readable medium of claim 11, wherein the disk access metric includes at least one metric selected from the group consisting of: a count of data segments being closed to further writes; a count of data segments being opened to further writes; a count of host I/Os; and a count of host writes.

13. The non-transitory machine readable medium of claim 10 comprising further machine executable code which causes the machine to:
determine a first rate at which data within a first segment of the plurality of data segments has been invalidated since a first point in time;
determine a second rate at which data within the first segment of the plurality of data segments has been invalidated since a second point in time subsequent to the first point in time;
assign the garbage collection score to the first segment of the plurality of data segments further based on a ratio of the second rate to the first rate.

14. The non-transitory machine readable medium of claim 13, wherein the second point in time corresponds to a previous garbage collection process.

15. The non-transitory machine readable medium of claim 13, wherein the garbage collection score is selected such that a likelihood that garbage collection is performed on a data segment of the plurality of data segments is inversely proportional to a ratio of the second rate to the first rate.

16. A computing device comprising:
a memory containing machine readable medium comprising machine executable code having stored thereon instructions for performing a method of garbage collection assessment;
a processor coupled to the memory, the processor configured to execute the machine executable code to cause the processor to:
identify a plurality of data segments; and
for each of the plurality of data segments:
determine a first rate at which data within the respective data segment has been invalidated since a first point in time;
determine a second rate at which data within the respective data segment has been invalidated since a second point in time subsequent to the first point in time;
compare the second rate to the first rate; and
assign a garbage collection score to the respective data segment based on the comparison of the second rate to the first rate of the respective data segment.

17. The computing device of claim 16, wherein the second point in time corresponds to a previous garbage collection process.

18. The computing device of claim 16, wherein the garbage collection score is selected such that a likelihood that garbage collection is performed on a data segment of the plurality of data segments is inversely proportional to a ratio of the second rate to the first rate.

19. The computing device of claim 16, wherein the processor is further configured to execute the machine executable code to assign the garbage collection score to each of the plurality of data segments further based on at least one attribute selected from the group consisting of: a utilization of the respective data segment and an age of the respective data segment.

20. The computing device of claim 19, wherein the at least one attribute is selected to include the age of the respective data segment, and wherein the age of the respective data segment is represented in a disk access metric.
